(19) United States
(12) Patent Application Publication
(10) Pub. No.: US 2026/0145911 A1
(43) Pub. Date: May 28, 2026

(54) CAR FOR AN ELEVATOR, AND ELEVATOR

(71) Applicant: Inventio AG, Hergiswil (CH)

(72) Inventors: Robert Marks, Lothian, MD (US); Ajay Anand, Harrison, NJ (US)

(21) Appl. No.: 19/123,109

(22) PCT Filed: Oct. 16, 2023
(86) PCT No.: PCT/EP2023/078664

§ 371 Date: Apr. 22, 2025

(30) Foreign Application Priority Data
Oct. 28, 2022 (EP) 22204277.2

(51) Int. Cl. B66B 11/00; B66B 1/12; B66B 5/00; B66B 11/02; B66B 13/06; B66B 13/14

(52) U.S. Cl. CPC B66B 11/0025; B66B 1/12; B66B 5/0081; B66B 5/0087; B66B 11/004; B66B 11/0226; B66B 13/06; B66B 13/143

(57) ABSTRACT

A car for an elevator has a railing on a top of the car for protecting a maintenance worker from falling off the top of the car. A main control unit, and/or a control subunit, for manually controlling a vertical movement of the car and/or an opening or closing of the car is arranged within the railing.

### FIELD

The technology described herein generally relates to a car for an elevator, and an elevator. More particularly, the technology relates to a car for ensuring a safe maintenance of the elevator.

### BACKGROUND

Elevators serve for transporting passengers with an elevator car throughout a building. Typically, a multiplicity of passengers may be accommodated within an interior of the car and may then be transported for example from a first floor to a second floor in the building. In this description, the terms “first” and “second” are used in this context only to differentiate one floor from another and not for stating that e.g. the first floor is in fact the first floor of the building. Therefore, the first and second floor may be any two different floors of a building. During such travel, further passengers may enter or exit the car during intermediate stops at other floors. The car moves vertically from one floor to the other through a hoistway of the building.

Such an elevator has to be maintained by a maintenance worker on a regular basis, e.g. in accordance with a regular maintenance interval or because of a fault of the elevator. The maintenance worker may face different dangerous situations, which pose a threat to the worker, when maintaining the elevator. For example, the worker may have to access a top of the car in order to be able to maintain the elevator. Entering the top of the car is dangerous, because of the depth of the hoistway, because of the movement of the car, because of the movement of another car in the hoistway, because of other moving objects in the hoistway, such as a counterweight of the elevator or the other elevator, and/or because of dangerous devices in the hoistway, e.g. devices being operated with high voltage and/or high voltage current. Therefore, some elevators may comprise a railing on top of the car for protecting the maintenance worker from falling off the top of the car.

Further, a main control unit, a control subunit, and/or an emergency stop unit may be arranged in corresponding casings on top of the car, in particular within an inner region of the top of the car, with the inner region being at least in part surrounded by the above railing. However, these casing represent obstacles for the maintenance worker on top of the car, over which the maintenance worker may fall, and which reduce the working space for the maintenance worker on top of the car. These issues may represent further safety risks for the maintenance worker.

CN 2017 46 203 U describes an elevator car with a car roof overhaul platform, which comprises a car roof guardrail, a foot board bracket and an overhaul foot board installed on the foot board bracket.

EP 1 663 839 B1 describes an elevator car which comprises a cross-head portion and a balustrade mounted to the cross-head portion, wherein the balustrade is moveable from a retracted position for normal operation of the car to a deployed position for inspection operation of the car.

JP 2004 359 467 A describes a controller for an elevator facility, wherein the controller has an actuating element on a front face and has an insert in the form of key-operated switch cylinder having a recessed part, namely, a key slot.

WO 2019 092 003 A1 describes an elevator car which comprises a balustrade mounted on a roof of the elevator car. The balustrade is equipped with lights for creating emergency lighting. The lights are LED lights which are located on the handrail of the balustrade.

EP 3 247 664 B1 describes an elevator having a car with a car roof comprising a barrier for anti-fall safety purposes. The barrier has a toeboard, and at least some of the cables for the car electrical system are routed within the toeboard.

Accordingly, there is a need for a car for an elevator which contributes to the safety of a maintenance worker. In particular, there is a need for a car for an elevator which contributes to the safety of a maintenance worker working on top of the car.

### SUMMARY

Such needs are met by the subject-matter of the advantageous embodiments defined in the following specification and the associated figures.

According to a first aspect of the technology described herein, a car for an elevator comprises a railing on top of the car for protecting a maintenance worker from falling off the top of the car, and a main control unit for manually controlling a vertical movement and/or an opening or closing of the car, wherein the main control unit is arranged within the railing. The railing may be formed such that at least one part of the railing, e.g. a part of a handrail or of a vertical post of the railing, encloses an inner space, in other words a chamber, in which at least a part of the main control unit is arranged. For example, the part of the railing enclosing the chamber may comprise a U-profile or any other hollow profile in which the main control unit may be arranged. The railing may be formed and arranged such that it at least partly surrounds an inner region of the top of the car. The railing may be fixed to a roof of the car. The railing may be referred to as barrier or balustrade.

Arranging the main control unit within the railing may enable to omit a stand-alone and/or isolated control unit having an extra casing on top of the car. This may contribute to that there is more space for the maintenance worker on top of the car, in particular within the inner region on the top of the car. This may contribute to the safety of the maintenance worker when working on the top of the car. So, arranging the main control unit within the railing may contribute to the safety of the maintenance worker.

That the main control unit is configured for manually controlling the vertical movement of the car may mean in this context that the car may be driven up and down or may be stopped via manually operating the main control unit, e.g. by the maintenance worker. That the main control unit is configured for opening and closing the car may mean in this context that a door of the car, e.g. a sliding door, which closes or exposes an interior of the car, may be manually controlled via the main control unit, e.g. by the maintenance worker.

According to one embodiment, the railing comprises a vertical first post, wherein the main control unit is arranged in the first post. The first post may easily be designed sufficiently large for accommodating the main control unit without wasting much space on top of the car. The railing may comprise two or more vertical posts, i.e. the first post and a second post, and at least one horizontal handrail extending from the first post to the second post. Preferably, the railing comprises four vertical posts and at least three horizontal handrails connecting the vertical posts. In one of these cases, the control unit may alternatively be arranged in one of the handrails. The first post may be fixed to the roof of the car. The first post may be referred to as barrier post or balustrade post.

According to one embodiment the car comprises the sliding door for entering the interior of the car, wherein the sliding door is arranged at a front of the car and wherein the first post is arranged at the front of the car. This may enable the maintenance worker to operate the main control unit from the front of the car, in particular without climbing on the top of the car. In other words, the maintenance worker may stand on a floor, i.e. for example at an open elevator shaft door, while the elevator is stopped in a position such that its roof is accessible via the opened shaft door and, in such situation, the maintenance worker may reach out to the main control unit and operate the main control unit without having to climb onto the car's roof. If the car comprises another sliding door at a back of the car, a control subunit or an emergency stop unit as explained below may be arranged on top of the back of the car. The sliding door(s) may be telescope sliding doors.

However, it would also be conceivable that the first post is arranged at a rear side of the car. The rear side is allocated to an opposite side with respect to the front of the car.

According to one embodiment, the main control unit comprises a first casing providing a first chamber in which one or more electronic devices for controlling the car are arranged, and a first pivoting door for opening and closing an opening of the first casing. The first pivoting door may enable to easily access the electronic devices within the first chamber. The first pivoting door may be coupled to the first casing by one or more first hinges. The first casing may be formed by a part of the first post. For example, the first post may comprise a U-profile or any other hollow profile forming the first casing, and may enclose an inner space forming the first chamber. Alternatively, the first casing may be at least partly arranged within the first post. For example, the first post may comprise a U-profile or any other hollow profile and may enclose an inner space in which the first casing enclosing the first chamber may be arranged.

According to one embodiment the first pivoting door is formed and arranged such that a front side of the first pivoting door faces the inner region of the top of the car in a closed state of the first pivoting door. In other words, the first pivoting door may be formed and arranged such that the front side of the first pivoting door faces the inner region of the top of the car in the closed state of the first pivoting door. This contributes to that the front side of the first pivoting door may be easily accessed by the maintenance worker in the closed state of the first pivoting door. This may be particularly advantageous, if one or more control elements for operating the main control unit are arranged at the front side of the first pivoting door. Alternatively or additionally, the first pivoting door is pivotable towards an outside of the top of the car. In other words, the first pivoting door may be formed and arranged such that the front side of the first pivoting door faces the outside of the top of the car in the opened state of the first pivoting door. This may contribute to that the first chamber is comfortable accessible from the top of the car and/or that the opened first pivoting door does not waste any space on top of the car, in particular within the inner region, when the first pivoting door is in its opened state. This may contribute to the safety of the maintenance worker.

For example, the first pivoting door may be coupled to the first casing by at least one first hinge, wherein the first hinge is arranged at a side or next to the side of the first casing facing the front of the car. One or more first control elements for operating the electronic devices of the main control unit may be arranged at the front side of the first pivoting door, wherein the control elements may be configured for being controlled by the maintenance worker of the car. The control elements and/or electronic devices of the main control unit may be configured such that they may be operated, when the first pivoting door is in its open state. This may contribute to easily operate the main control unit from the front of the car, e.g. without climbing on the top of the car. This may contribute to the safety of the maintenance worker. The front side of the first pivoting door may be a first side of the first pivoting door, whereas a back side of the first pivoting door may be a second side of the first pivoting door.

According to one embodiment the railing comprises a vertical second post, the car comprises a control subunit for manually controlling the car, and the control subunit is arranged in the second post. The control subunit within the second post may enable to arrange even more control devices, i.e. the electronic devices, and corresponding control elements on top of the car without wasting additional space on top of the car. Further, the control subunit may enable the maintenance worker to control the car from another position on top of the car. This may contribute to the safety of the maintenance worker on the top of the car, because he/she may operate the control elements fast and/or without walking around on the top of the car. The second post may be arranged at the same side of the car as the sliding door, i.e. the front of the car, in particular opposite to the first post. This may enable the maintenance worker to operate the control subunit from the front of the car, in particular without climbing on the top of the car.

According to one embodiment, the control subunit comprises a second casing providing a second chamber in which one or more further electronic devices for controlling the car are arranged, and a second pivoting door for opening and closing an opening of the second casing, wherein the first and second pivoting doors have the same shape. This may enable to use the same type of pivoting door for both control units. This may contribute to keep a number of different parts to be produced for the control units low. This may contribute to keep manufacturing costs for manufacturing the control units low. The second pivoting door may enable to easily access the further electronic devices within the second chamber. The second casing may be formed by a part of the second post. For example, the second post may comprise a U-profile or any other hollow profile forming the second casing, and may enclose an inner space forming the second chamber. Alternatively, the second casing may be at least partly arranged within the second post. For example, the second post may comprise a U-profile or any other hollow profile and may enclose an inner space in which the second casing enclosing the second chamber may be arranged. The first and second posts, and the main control unit and the control subunit may be arranged such that the front side of the main control unit, which corresponds to the front side of the first pivoting door, faces a front side of the control subunit, which corresponds to a front side of the second pivoting door, in a closed state of the first and second pivoting doors. The control elements and/or the electronic devices of the control subunit may be configured such that they may be operated, when the second pivoting door is in its open state. This may contribute to easily operate the control subunit from the front of the car, e.g. without climbing on the top of the car. This may contribute to the safety of the maintenance worker.

According to one embodiment, the pivoting doors each have a first side and a second side corresponding to each other, and the second side of the first pivoting door faces the first chamber, and the first side of second pivoting door faces the second chamber. In other words, the first side of the first pivoting door may form the front side of the main control unit, and the second side of the second pivoting door may form the front side of the control subunit. In further other words, for the main control unit, the second side of the first pivoting door faces the first chamber and the first side of the first pivoting door faces the inner region of the top of the car, in the closed state of the first pivoting door; and, for the control subunit, the first side of the second pivoting door faces the second chamber and the second side of the second pivoting door faces the inner region of the top of the car, in the closed state of the second pivoting door. This may contribute to use identical doors for the main control unit and the control subunit, even if hinges for pivoting the pivoting doors are arranged at the same side, i.e. the front of the car, and/or even if the pivoting doors may be opened in opposite directions, e.g. one in clockwise direction and the other in counter-clockwise direction.

According to one embodiment, the second pivoting door is formed and arranged such that the front side of the second pivoting door faces the inner region of the top of the car in the closed state of the second pivoting door. In other words, the second pivoting door may be formed and arranged such that the front side of the second pivoting door faces the inner region of the top of the car in the closed state of the second pivoting door. This contributes to that the front side of the second pivoting door may be easily accessed by the maintenance worker in the closed state of the second pivoting door. This may be particularly advantageous, if one or more control elements for operating the control subunit are arranged at the front side of the second pivoting door. Alternatively or additionally, the second pivoting door is pivotable towards the outside of the top of the car. In other words, the second pivoting door may be formed and arranged such that the front side of the second pivoting door faces the outside of the top of the car in the opened state of the second pivoting door. This may contribute to that the second chamber is comfortable accessible from the top of the car and/or that the opened second pivoting door does not waste any space within the inner region on the top of the car, when the second pivoting door is in its opened state. This may contribute to the safety of the maintenance worker.

For example, the second pivoting door may be coupled to the second casing by at least one second hinge, wherein the second hinge is arranged at a side or next to the side of the second casing facing the front of the car. One or more second control elements for operating the further electronic devices of the control subunit may be arranged at the front side of the second pivoting door, wherein the second control elements may be configured for being controlled by the maintenance worker of the car. So, the first pivoting door and the second pivoting door may be opened in opposite directions. For example, if the main control unit is arranged on a right side of the car, when looking at the car from the front of the car, and the control subunit is arranged at the left side of the car, the first pivoting door may be opened counter-clockwise, and the second pivoting door may be opened clockwise. The front side of the second pivoting door may be the second side of the second pivoting door.

According to one embodiment, the railing comprises a third post, the car comprises an emergency stop unit, and the emergency stop unit is arranged in the third post. The emergency stop unit may contribute to the safety of the maintenance worker, if he/she is working on the top of the car. For example, the third post may be spaced apart from the first and/or second post, e.g. at the back the car. This may enable the maintenance worker to stop the car without advancing the main control unit and/or the control subunit, in particular to stop the car from the back of the car. This may contribute to the safety of the maintenance worker. The emergency stop unit may be configured for overriding the other control units when being activated.

According to one embodiment, the third post comprises a support which is mechanically coupled to the top of the car, and the emergency stop unit is arranged in the support. Arranging the emergency stop unit within the support may enable to waste no space on top of the car for the emergency stop unit. This may contribute to the safety of the maintenance worker. The support may be configured for increasing a mechanical stability of the corresponding post and for accommodating the emergency stop unit.

According to one embodiment, the third post is arranged at a back of the car. This may enable the maintenance worker to operate the emergency stop unit from the back of the car and/or when working close to the back of the car, e.g. on top of the car.

The above features, advantages and/or effects of the car for the elevator may be transferred to the elevator explained in the following. In particular, the above features, advantages and/or effects of the embodiments of the technology described herein are described partly with respect to the above car and partly with respect to the elevator, explained in the following. One skilled in the art will recognize that these features, advantages and/or effects may be suitably transferred from one embodiment to another and/or from the above first aspect to the second aspect. Therefore, with due regard to a concise description of the present invention, a repetitive explanation of these features, advantages and/or effects is omitted in the following and it is referred to the above explanations only. Further, features of different embodiments may be modified, adapted, combined and/or replaced, etc. in order to come to further embodiments of the technology described herein.

According to a second aspect of the technology described herein, the elevator is proposed. The elevator comprises the above car, wherein the car is arranged in a hoistway such that the car is vertically movable within the hoistway.

According to one embodiment, the elevator comprises a motor being coupled to the car and being configured to move the car vertically within the hoistway; and an opening mechanism for granting and denying access to an interior of the car, wherein the main control unit and/or the control subunit are coupled to the motor for controlling the motor and as such the vertical movement of the car, and/or to the opening mechanism for controlling the access to the interior of the car. The opening mechanism may be configured for opening and closing the sliding door(s) of the car. In case of the emergency stop unit being arranged, the emergency stop unit may be coupled to the motor also.

In the following, advantageous embodiments of the technology described herein will be described with reference to the enclosed drawings. However, neither the drawings nor the description shall be interpreted as limiting the technology described herein.

### DESCRIPTION OF THE DRAWINGS

FIG. 1 shows an embodiment of an elevator and of a car of the elevator, according to an embodiment of the technology described herein.

FIG. 2 shows a sectional side view of a top of the car of FIG. 1.

FIG. 3 shows a side view of a post of a railing on top of the car of FIG. 1.

FIG. 4 shows a perspective view of a main control unit within the post of FIG. 3, in an opened state.

FIG. 5 shows an embodiment of a railing of the car of FIG. 1.

FIG. 6 shows a perspective view of an embodiment of a pivoting door for a main control unit and/or a control subunit for the car of FIG. 1.

FIG. 7 shows a perspective view of an embodiment of a railing of the car of FIG. 1.

FIG. 8 shows a perspective view of an embodiment of an emergency unit of the car of FIG. 1.

The figures are only schematic and not to scale. Same reference signs refer to same or similar features.

### DETAILED DESCRIPTION

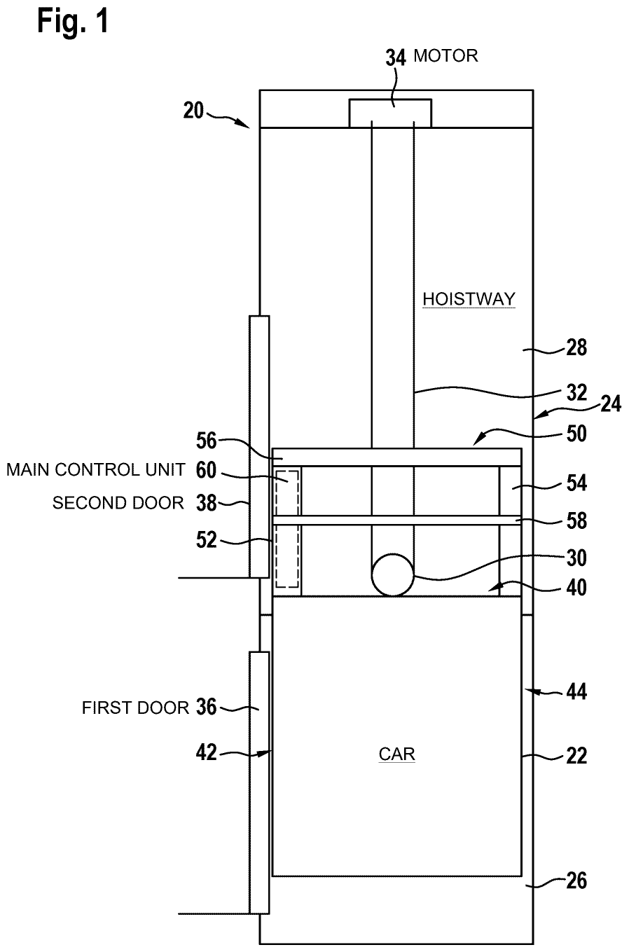

FIG. 1 shows an elevator 20 according to an embodiment of the technology described herein. The elevator 20 comprises a car 22, a hoistway 24, a car holder 30, a cable 32, a motor 34, a first door 36 and a second door 38. The car 22 comprises a railing 50 on a top 40 of the car 22 and a main control unit 60 being arranged within the railing 50.

The main control unit 60 may be configured for manually controlling a vertical movement of the car 22 within the hoistway 24. This may mean in this context that the car 22 may be driven up and down or may be stopped via manually operating the main control unit 60, e.g. by a maintenance worker. The main control unit 60 may be further configured for denying or granting an access to the car 22, e.g. via closing and, respectively, opening the first and second hoistway doors 36, 38. The main control unit 60 may be manually controlled by the maintenance worker.

The elevator 20 may be arranged in a building having several floors. In particular, the building may have a first floor 26 and a second floor 28, wherein in this context the terms “first” and “second” are only used to differentiate one floor from another and may refer to any of the floors of the building. The elevator 20 may be arranged for transporting a load, e.g. one or more people and/or any another load, from one floor to the other, for example from the first floor 26 to the second floor 28 or vice versa.

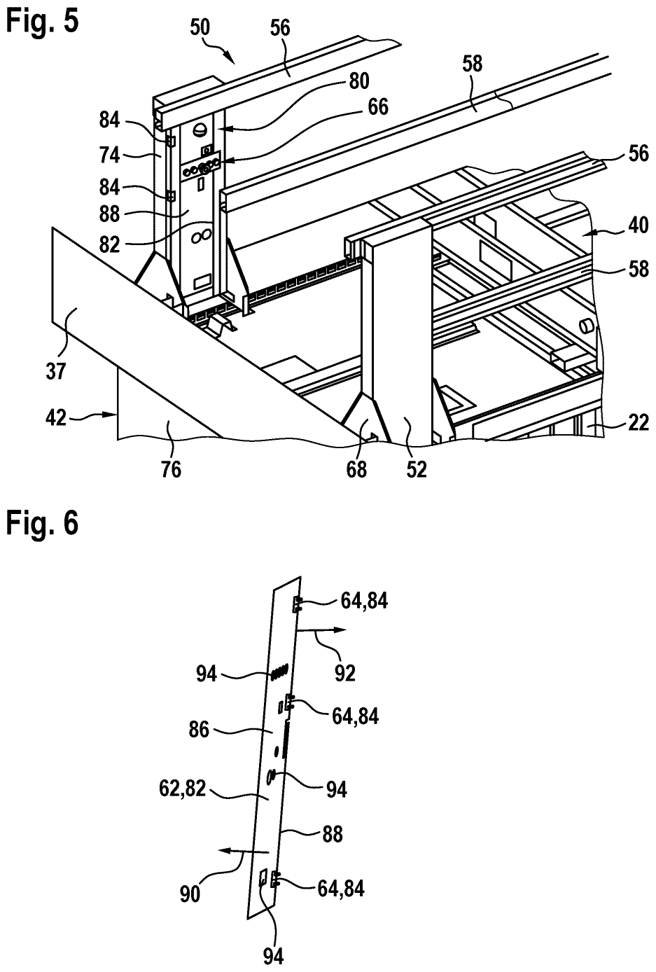

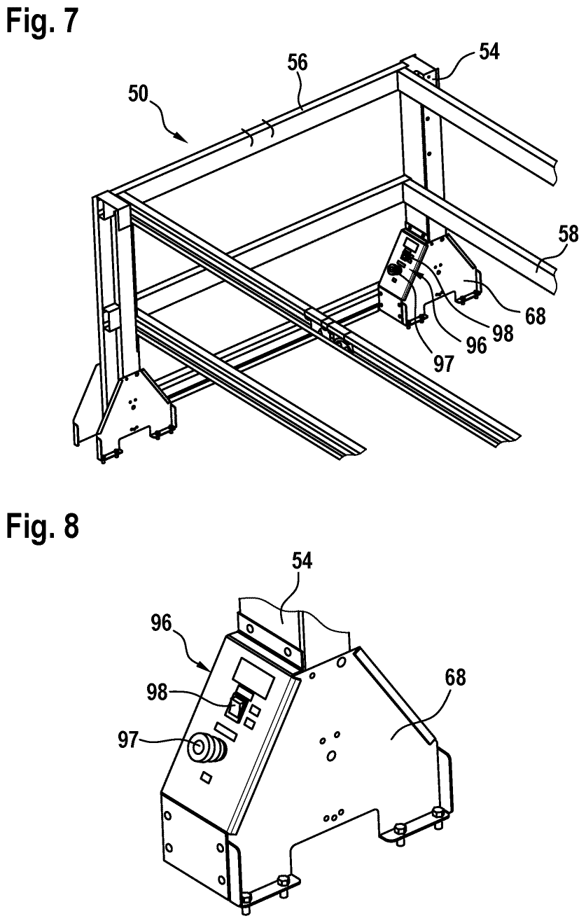

The car 22 may be configured for accommodating the load, i.e. the one or more people and/or the other load. The load and/or the people may enter the car 22 through the first door 36, if the car 22 is at the first floor 26, or the second door 38, if the car 22 is at the second floor 28. The car 22 may comprise a maintenance flap (not shown) through which the maintenance worker may climb on the top 40 of the car 22. The car 22 may be held and may be vertically transported within the hoistway 24 by the attached car holder 30 and the cable 32. The cable 32 may be moved by the motor 34. The motor 34 may be controlled by the main control unit 60. Additionally, the elevator 20 may comprise one or more further controllers, which may communicate with the main control unit 60, e.g. a control subunit 80 (see FIG. 5) and/or an emergency stop unit 96 (see FIGS. 7 and 8). A front 42 of the car 22 may face the doors 36, 38 when the car 22 is arranged at the corresponding floor 24, 26, whereas a back 44 of the car 22 may face away from the doors 36, 38.

The railing 50 on the top 40 of the car 22 is arranged for protecting the maintenance worker from falling off the top 40 of the car 22. The railing 50 may at least partly surround an inner region of the top 40 of the car 22. The main control unit 60 is arranged within the railing 50. The railing 50 may comprise one or more handrails, e.g. one or more first handrails 56 and/or one or more second handrails 58, wherein the second handrail(s) 58 may be arranged between the top 40 of the car 22 and the first handrail(s) 56. The railing 50 may comprise one or more vertical posts, e.g. a vertical first post 52, a vertical second post 74 (see FIG. 5), and a vertical third post 54. The first and second posts 52, 74 may be arranged at the front 42 of the top 40 of the car 22, whereas the third post 54 may be arranged at the back 44 of the top 40 of the car 22. In particular, the first post 52 may be spaced apart from the second post 74, and the third post 54 may be spaced apart from the first and/or second post 52, 74. The railing 50 may comprise one or more further posts. The handrails 56, 58 each may extend from one of the posts 52, 54, 74 to one of the other posts 52, 54, 74.

The railing 50 may be formed such that at least one part of the railing 50, e.g. a part of the handrails 56, 58 or of the posts 52, 54, 74, encloses an inner space, in other words a chamber, in which at least a part of the main control unit 60 may be arranged. For example, the part of the railing 50 enclosing the corresponding chamber may comprise a U-profile or any other hollow profile which may form a casing, which may be referred to as first casing, of the main control unit 60 or in which the first casing of the main control unit 60 may be arranged.

For example, the main control unit 60 may be arranged in the first post 52. Alternatively, the main control unit 60 may be arranged in another one of the posts 54, 74 or in one of the handrails 56, 58. The first post 52 may be arranged at the front 42 and on the top 40 of the car 22, in other words at the front 42 of the top 40 of the car 22. The first post 52 accommodating the main control unit 60 may be arranged such that the maintenance worker is able to operate the main control unit 60 from the front 42 of the car 22, in particular without climbing on the top 40 of the car 22.

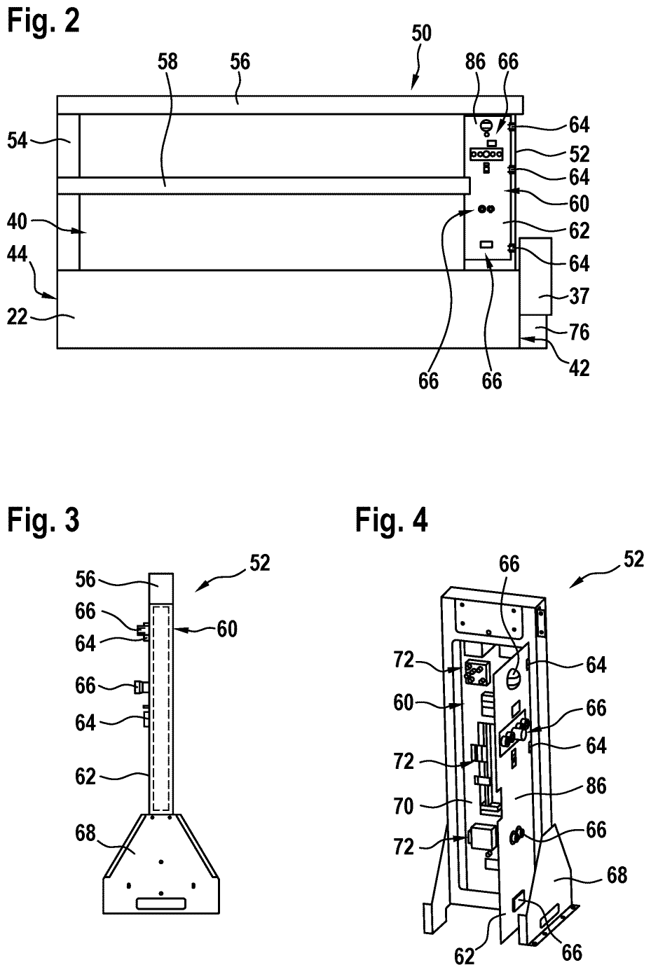

FIG. 2 shows a sectional side view of the top 40 of the car 22 of FIG. 1, in which a front side of the main control unit 60 is visible. FIG. 3 shows a side view of a post of the railing 50 on the top 40 of the car 22 of FIG. 1, in particular of the first post 52 accommodating the main control unit 60. FIG. 4 shows a perspective view of the main control unit 60 within the post of FIG. 3, i.e. the first post 52, in an opened state.

The main control unit 60 may comprise a first casing providing a first chamber 70 in which one or more electronic devices 72 for controlling the car 22 are arranged. The main control unit 60 may comprise a first pivoting door 62 for opening and closing an opening of the first casing. The first pivoting door 62 may enable an access the electronic devices 72 within the first chamber 70. The first pivoting door 62 may be coupled to the first casing by one or more first hinges 64. The first casing may be formed by a part of the first post 52. For example, the first post 52 may comprise a U-profile or any other hollow profile forming the first casing, and may enclose an inner space forming the first chamber 70. Alternatively, the first casing may be at least partly arranged within the first post 52. For example, the first post 52 may comprise the U-profile or the other hollow profile and may enclose the inner space in which the first casing enclosing the first chamber 70 may be arranged.

The first pivoting door 62 may be formed and arranged such that a front side of the first pivoting door 62, which may correspond to a front side of the main control unit 60, faces the inner region of the top 40 of the car 22 in a closed state of the first pivoting door 62. In other words, the first pivoting door 62 may be formed and arranged such that the front side of the first pivoting door 62 faces the inner region of the top 40 of the car 22 in the closed state of the first pivoting door 62. Alternatively or additionally, the first pivoting door 62 may be pivotable towards an outside of the top 40 of the car 22. In other words, the first pivoting door 62 may be formed and arranged such that the front side of the first pivoting door 62 faces the outside of the top 40 of the car 22 in the opened state of the first pivoting door 62. For example, the first pivoting door 62 may be coupled to the first casing by at least one first hinge 64, wherein the first hinge(s) 64 may be arranged at a side or next to the side of the first casing facing the front 42 of the car 22.

One or more control elements 66 for operating the electronic devices 72 of the main control unit 60 may be arranged at the front side of the first pivoting door 62. The control elements 66 may be configured for being controlled by the maintenance worker of the car 22. The control elements 66 may comprise one or more knobs, buttons, displays, touch-screens, etc. The control elements 66 may comprise a buzzer, one or more lamps, e.g. a seismic lamp, a flood lamp, a power socket, and/or a light switch. The electronic devices 72 may comprise one or more printed circuit boards, inverters, converters, rectifiers, microchips, resistors, capacitors, inductances, amplifiers, filters, etc. Optionally, one or more lamps for illuminating the top 40 of the car 22 may be arranged at one or more of the posts 52, 54, 74, e.g. on the first post 52 and/or at the first casing of the main control unit 60.

The control elements 66 and/or the electronic devices 72 may be configured such that they may be operated, when the first pivoting door 62 is in its open state. This may contribute to easily operate the main control unit 60 from the front 42 of the car 22, e.g. without climbing on the top 40 of the car 22.

From FIG. 2 may be seen that the car 22 may comprise a sliding door 76 for denying or granting access to the interior of the car 22. The sliding door 76 may be configured as a telescope sliding door. The main control unit 60 may be configured for driving the sliding door 76. For example, the main control unit 60 may be configured for controlling an opening mechanism 37, which is coupled to the sliding door 76, and may be configured to open or close the sliding door 76 upon receiving a corresponding signal from the corresponding controller, e.g. the main control unit 60 of the elevator 20. The sliding door 76 may be arranged at the front 42 of the car 22. Optionally, the car 22 may comprise another sliding door (not shown) at the back 44 of the car 22. If the car 22 comprises the other sliding door at the back 44 of the car 22, a control subunit 80 or an emergency stop unit 96 as explained below may be arranged on the top 40 of the back 44 of the car 22.

From FIGS. 3 and 4 it may be seen that the first post 52 may comprise a support 68. The support 68 may be arranged at a bottom section of the first post 52. The support 68 may be arranged for coupling the rest of the first post 52 to the top 40 of the car 22. The other posts 54, 74 of the railing 50 may comprise corresponding supports 68. The supports 68 may be configured for enhancing a stability of the corresponding post 52, 54, 74 and thereby of the railing 50.

FIG. 5 shows an embodiment of the railing 50 for the car 22 of FIG. 1. In this embodiment, a control subunit 80 may be arranged in the second post 74 of the railing 50. The main control unit 60 and the control subunit 80 may be in a master-slave relationship as it is known in the art. The control subunit 80 may provide the same functions as the main control unit 60, a subgroup of functions of the main control unit 60, or other functions as the main control unit 60. The second post 74 may be arranged at the same side of the car 22 as the sliding door 76, i.e. the front 42 of the car 22, in particular opposite to the first post 52. The second post 74 and the control subunit 80 may be arranged such that the maintenance worker is able to operate the control subunit 80 from the front 42 of the car 22, in particular without climbing on the top 40 of the car 22.

The control subunit 80 may comprise a second casing providing a second chamber (not shown) in which one or more further electronic devices (not shown) for controlling the car 22 are arranged. The control subunit 80 may comprise a second pivoting door 82 for opening and closing an opening of the second casing. The second pivoting door 82 may enable to easily access the further electronic devices within the second chamber. One or more of the control elements 66 may be arranged at a front side of the second pivoting door 82, wherein the control elements 66 at the second pivoting door 82 may be configured for operating the further electronic devices within the second chamber.

The second casing may be formed by a part of the second post 74. For example, the second post 74 may comprise a U-profile or any other hollow profile forming the second casing, and may enclose an inner space forming the second chamber. Alternatively, the second casing may be at least partly arranged within the second post 74. For example, the second post 74 may comprise a U-profile or any other hollow profile and may enclose an inner space in which the second casing enclosing the second chamber may be arranged.

The second pivoting door 82 may be formed and arranged such that a front side of the second pivoting door 82 faces the inner region of the top 40 of the car 22 in the closed state of the second pivoting door 82. In other words, the second pivoting door 82 may be formed and arranged such that the front side of the second pivoting door 82 faces the inner region of the top 40 of the car 22 in the closed state of the second pivoting door 82. Alternatively or additionally, the second pivoting door 82 may be pivotable towards the outside of the top 40 of the car 22. In other words, the second pivoting door 82 may be formed and arranged such that the front side of the second pivoting door 82 may face the outside of the top 40 of the car 22 in the opened state of the second pivoting door 82. For example, the second pivoting door 82 may be coupled to the second casing by at least one second hinge 84, wherein the second hinge(s) 84 may be arranged at a side or next to the side of the second casing facing the front 42 of the car 22.

So, the first pivoting door 62 and the second pivoting door 82 may be opened in opposite directions. For example, if the main control unit 60 is arranged on a right side of the car 22, when looking at the car 22 from the front 42 of the car 22, and the control subunit 80 is arranged at the left side of the car 22, the first pivoting door 62 may be opened counter-clockwise and the second pivoting door 82 may be opened clockwise.

One or more control elements 66 for operating the further electronic devices of the control subunit 80 may be arranged at the front side of the second pivoting door 82, wherein these control elements 66 may be also configured for being controlled by the maintenance worker of the car 22. Optionally, one or more lamps for illuminating the top 40 of the car 22 may be arranged at the second post 74 and/or at the second casing of the control subunit 80. The control elements 66 and/or the electronic devices 72 of the control subunit 80 may be configured such that they may be operated, when the second pivoting door 82 is in its open state. This may contribute to easily operate the control subunit 80 from the front 42 of the car 22, e.g. without climbing on the top 40 of the car 22.

FIG. 6 shows a perspective view of an embodiment of the pivoting doors 62, 82 for the main control unit 60 and/or, respectively, the control subunit 80 for the car 22 of FIG. 1. As may be seen from FIG. 6, the first and second pivoting doors 62, 82 may have the same, in particular identical, shape. In this case, the same type of pivoting door 62, 82 may be used for both of the control units 60, 80, even if the hinges 64, 84 for pivoting the pivoting doors 62, 82 are arranged at the same side, i.e. the front 42, of the car 22, and/or even if the pivoting doors 62, 82 may be opened in opposite directions, e.g. one in clockwise direction and the other in counter-clockwise direction. Mounting apertures 94 are provided for the control elements 66.

The pivoting doors 62, 82 each may have a first side 86 and a second side 88 corresponding to each other. The second side 88 of the first pivoting door 62 may be configured for facing the first chamber 70, and the first side 86 of second pivoting door 82 may be configured for facing the second chamber. In other words, for the main control unit 60 the second side 88 of the first pivoting door 62 may face the first chamber 70, and for the control subunit 80 the first side 86 of the second pivoting door 82 faces the second chamber. In further other words, the first side 86 of the first pivoting door 62 may form the front side of the main control unit 60, and the second side 88 of the second pivoting door 82 may form the front side of the control subunit 80. So, the front side of the first pivoting door 62 may be the first side 86 of the first pivoting door 62 and may face in a first direction 90, whereas a back side of the first pivoting door 62 may be a second side 88 of the first pivoting door 62, and the front side of the second pivoting door 82 may be the second side 88 of the second pivoting door 82 and may face in a second direction 92, whereas a back side of the second pivoting door 82 may be the first side 86 of the second pivoting door 82.

The first and second posts 52, 74, and the main control unit 60 and the control subunit 80 may be arranged such that the front side of the main control unit 60, which corresponds to the front side of the first pivoting door 62, faces the front side of the control subunit 80, which corresponds to the front side of the second pivoting door 82, in a closed state of the first and second pivoting doors 62, 82.

FIG. 7 shows a perspective view of an embodiment of the railing 50 for the car 22 of FIG. 1. FIG. 8 shows a perspective view of an embodiment of an emergency stop unit 96 for the car 22 of FIG. 1. The emergency stop unit 96 may be configured for overriding the other control units 60, 80 when being activated. The emergency stop unit 96 may comprise a stop button 97 for stopping the car 22. Optionally, the emergency stop unit 96 may comprise one or more switches 98, e.g. for switching on one or more lamps for illuminating the top 40 of the car. The emergency stop unit 96 may be arranged in the third post 54. For example, the third post 54 may comprise the corresponding support 68 which is mechanically coupled to the top 40 of the car 22, and the emergency stop unit 96 may be arranged in the support 68.

The support 68 and/or the emergency stop unit 96 may be formed such that an operating side of the support 68, at which the stop button 97 and/or the switches 98 are arranged, is tilted with respect to a horizontal plane of the top 40 of the car 22 and to the vertical rest of the third post 54. The support 68 may be configured such that it is easily removable from the rest of the third post 54. For example, the support 68 may be fixed to the rest of the third post 54 by one or more screws.

Finally, it should be noted that the term “comprising” does not exclude other elements or steps and the “a” or “an” does not exclude a plurality. Also elements described in association with different embodiments may be combined. Further, the invention is not restricted to the embodiments described above. For example, the railing 50 may comprise more or less handrails 56, 58 and/or posts 52, 54, 74.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A car for an elevator, the car comprising:
a railing arranged on top of the car adapted to protect a maintenance worker from falling off the top of the car;
a main control unit adapted to manually control a vertical movement and/or an opening or closing of the car, wherein the main control unit is arranged within the railing; and
wherein the railing includes a vertical first post and the main control unit is arranged in the first post.

16. The car according to claim 15 including a sliding door for entering an interior of the car, wherein the sliding door is arranged at a front of the car and wherein the first post is arranged on the top of the car at the front of the car.

17. The car according to claim 15 wherein the main control unit includes a casing, the casing forming a chamber in which one or more electronic devices for controlling the car are arranged, and a pivoting door for opening and closing an opening of the casing into the chamber.

18. The car according to claim 17 wherein the pivoting door is arranged such that a front side of the pivoting door faces an inner region of the top of the car in a closed state of the pivoting door and/or that the pivoting door is pivotable towards an outside of the top of the car.

19. The car according to claim 15 including a control subunit adapted to manually control the car, wherein the railing includes a vertical second post and the control subunit is arranged in the second post.

20. The car according to claim 19 wherein the control subunit includes a casing forming a chamber in which one or more electronic devices for controlling the car are arranged and a pivoting door for opening and closing an opening of the casing into the chamber.

21. The car according to claim 15 including:
wherein the main control unit includes a first casing, the first casing forming a first chamber in which one or more electronic devices for controlling the car are arranged, and a first pivoting door for opening and closing an opening of the first casing into the first chamber;
a control subunit adapted to manually control the car, wherein the railing includes a vertical second post and the control subunit is arranged in the second post;
wherein the control subunit includes a second casing forming a second chamber in which one or more further electronic devices for controlling the car are arranged, and a second pivoting door for opening and closing an opening of the second casing into the second chamber; and
wherein the first pivoting door and the second pivoting door have a same shape.

22. The car according to claim 21 wherein the first and second pivoting doors each have a first side and an opposite second side, the second side of the first pivoting door faces the first chamber in a closed state of the first pivoting door, and the first side of second pivoting door faces the second chamber in a closed state of the second pivoting door.

23. The car according to claim 21 wherein a front side of the second pivoting door faces an inner region of the top of the car in a closed state of the second pivoting door and/or the second pivoting door pivots towards an outside of the top of the car.

24. The car according to claim 15 including an emergency stop unit, wherein the railing includes a third post and the emergency stop unit is arranged in the third post.

25. The car according to claim 24 wherein the third post includes a support mechanically coupled to the top of the car and the emergency stop unit is arranged in the support of the third post.

26. The car according to claim 24 wherein the third post is arranged at a back of the top of the car.

27. An elevator comprising:
a hoistway; and
a car according to claim 15, the car being arranged in and vertically movable within the hoistway.

28. The elevator according to claim 27 including:
a motor coupled to the car, the motor adapted to move the car vertically within the hoistway;
an opening mechanism moving a car door of the car to grant and deny access to an interior of the car; and
wherein the main control unit is connected to the motor to control the vertical movement of the car within the hoistway, and/or is connected to the opening mechanism to control the access to the interior of the car.

29. An elevator comprising:
a hoistway;
a car according to claim 15, the car being arranged in and vertically movable within the hoistway;
a control subunit adapted to manually control the car, wherein the railing includes a vertical second post and the control subunit is arranged in the second post;
a motor coupled to the car, the motor adapted to move the car vertically within the hoistway;
an opening mechanism moving a car door of the car to grant and deny access to an interior of the car; and
wherein the main control unit and the control subunit are connected to the motor to control the vertical movement of the car within the hoistway, and/or are connected to the opening mechanism to control the access to the interior of the car.
